(19) United States
(12) Patent Application Publication
(10) Pub. No.: US 2017/0152325 A1
(43) Pub. Date: Jun. 1, 2017

(54) METHOD FOR ISOLATING ABS GRAFT COPOLYMERS

(71) Applicant: INEOS STYROLUTION GROUP GMBH, Frankfurt (DE)

(72) Inventors: Roland WALKER, Osnabrueck (DE); Sabine OEPEN, Ellerstadt (DE); Gisbert MICHELS, Leverkusen (DE)

(21) Appl. No.: 15/319,837

(22) PCT Filed: Jun. 17, 2015
(86) PCT No.: PCT/EP2015/063570

§ 371 Date: Dec. 19, 2016

(30) Foreign Application Priority Data
Jun. 25, 2014 (EP) 14173953.2

(51) Int. Cl. C08C 1/04; C08L 25/12; C08L 33/20; C08F 279/04

(52) U.S. Cl. CPC C08C 1/04; C08F 279/04; C08L 25/12; C08L 33/20

(57) ABSTRACT

A process for preparing an ABS graft copolymer, which comprises a step for isolating the graft copolymer B present in an aqueous dispersion by means of a precipitant which is an aqueous solution of a mixture of MgSO₄, Al₂(SO₄) and/or H₂SO₄, is described. The ABS molding compositions obtained have an improved yellowness index and high surface gloss.

The invention relates to a process for preparing isolating ABS graft copolymers.

It is known that natural rubbers can be coagulated by means of salt solutions. An overview of this is given by Rev. Gen. Cautchouc Indochine, Paris (1956, 33, 615-22 and 644-50).

WO 00/049053 describes ABS graft copolymers which are precipitated using a 0.5% strength by weight MgSO₄ solution and are treated with aqueous solutions of salts, alcohols, acids or sugars in a concentration of from 5 to 40% by weight to aid drying.

U.S. Pat. No. 5,514,772 describes a process for producing pulverulant polymers, which comprises two coagulation steps. In the first step, a surface-active sulfuric ester or sulfonic ester in combination with an acid is used for coagulation, while in the second step an acid and/or a salt is/are used for coagulation. Preference is given to the sole use of sulfuric acid.

The precipitates such as chlorides or sulfates which are usually employed in the industrial coagulation of graft copolymers from an emulsion or dispersion thereof have the disadvantage that residual amounts either have to be removed in a complicated fashion or remain in the product. This makes the production process more expensive or a deterioration in the quality of the processed finished product has to be accepted.

The deterioration in quality is usually attributable to the fact that when the graft copolymers are incorporated into a matrix, the precipitate residues interact with this matrix and, as a result, discoloration, in particular yellow discoloration (high yellowness index), occurs during subsequent processing to give the finished product. Surface defects in the finished product can also, for example, be caused by interactions between the precipitant residues and the materials of the machines used for producing the finished products.

Furthermore, it has been found that the precipitant residues can also undergo secondary reactions to form clusters and crystallites, which once again have an adverse effect on the quality of the finished products. In addition, the temperature resistance and/or the weathering stability can be impaired. In the case of transparent products, the residues of the precipitants can reduce the transparency, which is made apparent by an increase in the haze.

In DE 103 53 952, alkali metal and/or alkaline earth metal formates are used as precipitants for precipitating ABS graft copolymers. Test specimens of the graft copolymers with an SAN matrix were produced. An improvement in respect of yellowness index, transparency and haze of the specimens was able to be achieved. However, precipitation using alkali metal and/or alkaline earth metal formates has, inter alia, the disadvantage that such precipitants are too expensive for industrial use.

It is an object of the present to provide an alternative process for isolating ABS graft copolymers, which can be used industrially and remedies the abovementioned disadvantages of the known processes, so that ABS graft copolymers are obtained in good yield. The ABS molding compositions and molding obtained have a low yellowness index and high gloss.

The invention provides, in particular, a process for preparing ABS graft copolymers, which comprises a step for isolating the graft copolymer B present in an aqueous dispersion by means of a precipitant, wherein an aqueous solution a1) of the components

A1) and A2); A1) and A3); A2) and A3); or else A1), A2) and A3) is used as precipitant, where:
A1) is from 0.10 to 0.65% by weight of MgSO₄, based on the total amount of water, and
A2) is from 0.01 to 0.20% by weight of sulfuric acid, based on the total amount of water,
where the amount of A1) is greater than the amount of A2); or
A1) is from 0.1 to 0.65% by weight of MgSO₄, based on the total amount of water, and
A3) is from 0.01 to 0.40% by weight, based on the total amount of water, of an aluminum salt of sulfuric acid which is soluble in a monodisperse manner in water, preferably Al₂(SO₄)₃,
where the amount of A1) is greater than the amount of A3); or
A2) is from 0.01 to 0.20% by weight of sulfuric acid, based on the total amount of water, and
A3) is from 0.01 to 0.40% by weight, based on the total amount of water, of an aluminum salt of sulfuric acid which is soluble in a monodisperse manner in water, preferably Al₂(SO₄)₃; or
A1) is from 0.10 to 0.40% by weight of MgSO₄, based on the total amount of water,
A2) is from 0.01 to 0.10% by weight of sulfuric acid, based on the total amount of water, and
A3) is from 0.01 to 0.20% by weight, based on the total amount of water, of an aluminum salt of sulfuric acid which is soluble in a monodisperse manner in water, preferably Al₂(SO₄)₃,
where the amount of A1) is greater than the amount of A3) and the amount of A3) is greater than the amount of A2);
where the process does not comprise any further steps for isolation or for work-up in the presence of salts and/or acids;
and where the graft copolymer B has a bimodal particle size distribution and is made up of:
B1: from 40 to 85% by weight, based on the solids content of the graft copolymer B, of a graft base (B1) obtainable by (a) polymerization of:
   (B11): from 10.5 to 24.5% by weight, based on the graft base Bl, of at least one vinylaromatic, in particular styrene, and
   (B12): from 75.5 to 89.5% by weight, based on the graft base Bl, of at least one diene, in particular butadiene,
where (B11) and (B12) make up 100% by weight of B1;
   and
B2: from 15 to 60% by weight, based on the solids content of the graft copolymer B, of a graft shell obtainable by reaction of the graft base B1 with a mixture of:
   (B21) from 70 to 90% by weight, based on the graft shell (B2), of styrene and/or α-methylstyrene, in particular styrene, and
   (B22) from 10 to 30% by weight, based on the graft shell (B2), of acrylonitrile and/or methyl methacrylate, in particular acrylonitrile,
      where the total sum of graft base B1 and graft shell B2 makes up 100% by weight of B and the solids content of the graft copolymer in the aqueous dispersion is from 20 to 60% by weight.

The abovementioned concentrations (in % by weight) of the components A1), A2) and A3) are based on the total amount of water in the reactor (or reaction vessel). For the purposes of the present invention, the total amount of water is the amount of water in the total aqueous phase, i.e. the aqueous dispersion of the graft copolymer and the aqueous solution a1) of the precipitant.

### Graft Base (B1)

As diene component (B12), it is possible to use, for example, isoprene, butadiene and/or chloroprene, with preference being given to using isoprene and/or butadiene, particularly preferably butadiene.

As component (B11), it is possible to use styrene or styrene derivatives such as C₁-C₈-alkyl-substituted styrenes such as alpha-methylstyrene, m-methylstyrene, p-methylstyrene and p-t-butylstyrene, preferably alpha-methylstyrene and/or styrene; in particular, only styrene is used.

For the graft base B1, the diene component (B12) is generally used in an amount of from 75.5 to 89.5% by weight, in particular from 76 to 89% by weight, preferably from 78 to 88% by weight, very particularly preferably from 79 to 86% by weight, and the vinylaromatic component (B11) is generally used in an amount of from 10.5 to 24.5% by weight, in particular from 11 to 24% by weight, preferably from 12 to 22% by weight, very particularly preferably from 14 to 21% by weight.

Preference is given to a graft base B1 composed of butadiene and styrene in the abovementioned composition.

The preparation of the graft base B1 is known to those skilled in the art or can be carried out by methods known to those skilled in the art. Heterogeneous, particle-forming polymerization processes are preferred for preparation of the graft base B1. This dispersion polymerization can, for example, be carried out in a manner known per se by the method of emulsion polymerization, inverse emulsion polymerization, miniemulsion polymerization, microemulsion polymerization or macrosuspension polymerization in the feed stream process, continuously or batchwise. The graft base (B1) can also be prepared in the presence of an initially charged finely particulate latex (known as “seed latex” polymerization process). Suitable seed lattices consist, for example, of polystyrenes. According to the process of the invention, the graft base (B1) is firstly agglomerated by agglomerization processes to form larger particles after it has been prepared and before grafting.

To prepare the graft base (B1), the components (B12) and (B11) are polymerized in aqueous emulsion by methods known to those skilled in the art at temperatures of generally from 20 to 100° C., preferably from 50 to 90° C.

In a preferred embodiment, the addition of monomer is carried out in such a way that firstly only vinylaromatic (B11), in particular styrene, is added and polymerized in an amount of from 3 to 10% by weight, preferably from 5 to 8% by weight, based on the total amount of monomers (B11) and (B12). The addition of (B11) is preferably carried out over a period of from 5 to 30 minutes. This is usually followed by the addition and polymerization of a mixture of diene (B12) and remaining vinylaromatic (B11) at temperatures of from 30 to 80° C., preferably from 50 to 80° C., over a period of from 1 to 18 hours, preferably from 2 to 16 hours, particularly preferably from 4 to 12 hours. The introduction of the abovementioned monomer mixture into the initially charged reaction mixture can be carried out all at once, in a number of portions or preferably continuously during the polymerization.

The usual emulsifiers such as alkali metal salts of alkylsulfonic or arylsulfonic acids, alkyl sulfates, fatty alcohol sulfonates, salts of higher fatty acids having from 10 to 30 carbon atoms or hard soaps can be used in the polymerization. Preference is given to using the sodium or potassium salts of alkylsulfonates or fatty acids having from 10 to 18 carbon atoms. It is advantageous to use the emulsifiers in an amount of from 0.5 to 5% by weight, preferably from 0.5 to 2% by weight, based on the total weight of the monomers used for the graft base (B1). In general, the polymerization is carried out at a water/monomer ratio of from 2:1 to 0.7:1.

Polymerization initiators employed are, in particular, the customary persulfates such as potassium peroxodisulfate, but redox systems are also suitable.

The amounts of initiators, for example from 0.1 to 1% by weight, based on the total weight of the monomers used for preparing the graft base (B1), depends on the desired molecular weight.

As polymerization auxiliaries, it is possible to use the usual buffer substances by means of which pH values of preferably from 6 to 10, for example sodium bicarbonate and sodium pyrophosphate, and generally from 0.1 to 3% by weight of a chain transfer agent such as mercaptan, terpinol or dimeric α-methylstyrene.

The precise polymerization conditions, in particular type, metering and amount of the emulsifier, are selected within the ranges indicated above so that the graft base (B1) has particle sizes (average value d₅₀) in the range from 80 to 800 mm, preferably from 80 to 600 nm, particularly preferably from 85 to 400 mm.

The reaction conditions are selected so that the polymer particles have a bimodal particle size distribution, in particular a particle size distribution having two maxima, whose spacing can vary. The particle sizes and the distribution thereof can be determined by conventional methods. The first maximum is more distinct (peak comparatively narrow) than the second and is generally at from 25 to 200 mm, preferably from 60 to 170 mm and particularly preferably from 70 to 150 mm. The second maximum is comparatively broader and is generally at from 150 to 800 mm, preferably from 180 to 700 mm, particularly preferably from 200 to 600 mm.

The bimodal particle size distribution can be achieved by (partial) agglomeration of the polymer particles of the graft base B1. This can, for example, be effected by the following method:

The monomers B11 and B12, which build up the core, are firstly polymerized to a conversion of at least 90%, preferably more than 95%, based on the monomers B11 and B12. This conversion is generally achieved in from 4 to 20 hours. The rubber latex obtained has an average particle size d50 of not more than 200 mm and a narrow particle size distribution (virtually monodisperse system).

The rubber latex is then agglomerated. Through the effects on the agglomeration of the graft base (B1), use is made of a component (C) which has an agglomerating action and is preferably a copolymer made up of one or more hydrophobic C₁-C₁₂-alkyl alkylates, preferably C₁-C₄-alkyl acrylates, or C₁-C₁₂-alkyl methacrylates, preferably C₁-C₄-alkyl methacrylates, particularly preferably ethyl acrylate, and from 0.1 to 20% by weight, preferably from 0.1 to 10% by weight, of one or more polar monomers such as acrylic acid, methacrylic acid, acrylamide, methacrylamide, N-methylolmethacrylamide and N-vinylpyrrolidone, in particular methacrylamide.

The proportion of the hydrophobic monomers is generally from 80 to 99.9% by weight, preferably from 90 to 99.9% by weight, and the proportion of polar monomers is generally from 0.1 to 20% by weight, preferably from 0.1 to 10% by weight. Particular preference is given to a copolymer composed of from 92 to 98% by weight of ethyl acrylate and from 2 to 8% by weight of methacrylamide.

Preference is given to a copolymer (C) as described above which has a core made up of at least one of the abovementioned hydrophobic monomers, preferably ethyl acrylate, with this core being grafted with a copolymer composed of the abovementioned polar monomers.

The copolymer (C) is preferably used as aqueous dispersion, known as agglomeration latex.

The agglomeration of the graft base (B1) is generally effected by addition of a dispersion of the above-described copolymer (C). The concentration of the copolymer (C) in the dispersion used for agglomeration should generally be in the range of from 3 to 60% by weight, preferably from 5 to 40% by weight.

The agglomeration is generally carried out using from 0.1 to 5 parts by weight, preferably from 0.5 to 3 parts by weight, of the dispersion of the copolymer (C) per 100 parts of the graft base (B1), in each case calculated as solids.

The agglomeration is generally carried out at a temperature of from 20 to 120° C., preferably from 30 to 100° C., particularly preferably from 30 to 75° C. The copolymer C can be added all at once or in portions, continuously or with a feed profile over a particular period of time. The agglomeration time, i.e. the time from commencement of the addition of C to the start of the subsequent graft copolymerization, is preferably from one minute to a number of hours, for example up to 2 hours, particularly preferably from 10 to 60 minutes.

The pH during the agglomeration is generally from 6 to 13, preferably from 8 to 13.

Apart from the abovementioned dispersion of the copolymer (C), it is also possible to use other chemical agglomerating agents such as acetic anhydride for agglomerating the rubber latex. Physical methods such as freeze or pressure agglomeration processes can also be used. The methods mentioned are known to those skilled in the art.

The latex of the graft base B1 is only partially agglomerated under the abovementioned conditions, so that a bimodal particle size distribution results. More than 60%, preferably from 70 to 85%, of the particles (distribution by number) are generally in the unagglomerated state after the agglomeration. The resulting partially agglomerated latex of the graft base B1 is comparatively stable and therefore can readily, i.e. without coagulation occurring, be stored and transported.

In order to achieve a bimodal particle size distribution of the graft base B1, it is also possible, but less preferred, to prepare two different graft bases B1 and B1′ which differ in terms of their average particle size separately and mix these graft bases B1 and B1′ in the desired mixing ratio.

Graft Copolymer B

The graft copolymer B can be made up of the partially agglomerated graft base B1 and one or more graft shells B2. For the purposes of the present invention, the term graft copolymer B encompasses both a graft copolymer B alone and also a mixture of two or more different graft copolymers B. In a preferred embodiment, one graft copolymer B alone is used.

To produce the graft copolymers B according to the invention, the agglomerated graft base B1 is grafted with the monomers B21 and B22.

The graft copolymer B generally comprises from 40 to 85% by weight, based on the solids content of the graft copolymer B, of a graft base (B1) and from 15 to 60% by weight, based on the solids content of the graft copolymer B, of a graft shell (B2). The sum of B1 and B2 is 100% by weight.

The graft shell (B2) can be obtained by reaction of (B21) from 70 to 90% by weight, preferably from 75 to 85% by weight, of styrene and/or α-methylstyrene, in particular styrene, and from 10 to 30% by weight, preferably from 15 to 25% by weight, of acrylonitrile, methacrylonitrile and/or methyl methacrylate, in particular acrylonitrile, in the presence of the agglomerated graft base (B1). The sum of B21 and B22 is 100% by weight.

Preferred graft shells B2 are made up of: B2-1 copolymers of styrene and acrylonitrile, B2-2 copolymers of α-methylstyrene and acrylonitrile. Particular preference is given to B2-1 copolymers of styrene and acrylonitrile. Particularly preferred graft shells B2 are obtained by reaction of from 75 to 85% by weight of styrene and from 15 to 25% by weight of acrylonitrile.

The graft shell (B2) is preferably produced by an emulsion polymerization process after agglomeration of the graft base (B1).

The graft polymerization for producing the graft shell (B2) can be carried out in the same system as the emulsion polymerization for preparing the graft base (B1), with, if necessary, further emulsifiers and auxiliaries being able to be added. The monomer mixture to be grafted on can be added to the reaction mixture all at once, distributed over a plurality of stages, for example for building up a plurality of grafted layers, or continuously during the polymerization. The monomers B21 and B22 (in particular styrene and acrylonitrile) can preferably be added simultaneously.

The graft shell (B2) is, in one embodiment of the invention, polymerized from a monomer mixture consisting of the components B21 and B22, in particular styrene and acrylonitrile, in the presence of the agglomerated graft base (B1) obtained by the above-described method. Here, the monomers can be introduced individually or as mixtures with one another. For example, B21 alone can firstly be grafted on, followed by a mixture of B21 and B22. It is advantageous to carry out this graft copolymerization once again in aqueous emulsion under the usual conditions described above for the graft base.

Details regarding the procedure for the grafting reaction are known to those skilled in the art and are disclosed, for example, in DE-A 24 27 960 and EP-A 0 062 901.

Preference is given to using graft copolymers B made up of:
B1: from 40 to 85% by weight of a graft base (B1) obtainable by (a) polymerization of:
   (B11): from 11 to 24% by weight of vinylaromatic, in particular styrene, and
   (B12): from 76 to 89% by weight of diene, in particular butadiene, and
B2: from 15 to 60% by weight of a graft shell B2 obtainable by reaction of the agglomerated graft base B1 with a mixture of:
   (B21): from 70 to 90% by weight of styrene and/or α-methylstyrene, in particular styrene, and
   (B22): from 10 to 30% by weight of acrylonitrile and/or methyl methacrylate, in particular acrylonitrile.

Particular preference is given to using graft copolymers B made up of:
B1: from 40 to 85% by weight of a graft base (B1) obtainable by (a) polymerization of:
   (B11): from 12 to 22% by weight of vinylaromatic, in particular styrene, and
   (B12): from 78 to 88% by weight of diene, in particular butadiene, and
B2: from 15 to 60% by weight of a graft shell B2 obtainable by reaction of the agglomerated graft base B1 with a mixture of:
   (B21): from 70 to 90% by weight of styrene and/or α-methylstyrene, in particular styrene, and
   (B22): from 10 to 30% by weight of acrylonitrile and/or methyl methacrylate, in particular acrylonitrile.

Very particular preference is given to using graft copolymers B made up of:
B1: from 40 to 85% by weight of a graft base (B1) obtainable by (a) polymerization of:
   (B11): from 14 to 21% by weight of vinylaromatic, in particular styrene, and
   (B12): from 79 to 86% by weight of diene, in particular butadiene, and
B2: from 15 to 60% by weight of a graft shell B2 obtainable by reaction of the agglomerated graft base B1 with a mixture of:
   (B21): from 70 to 90% by weight of styrene and/or α-methylstyrene, in particular styrene, and
   (B22): from 10 to 30% by weight of acrylonitrile and/or methyl methacrylate, in particular acrylonitrile.

### Isolation of the Graft Copolymer

According to the invention, the graft copolymer B is isolated from an aqueous dispersion. For the present purposes, the aqueous phase of the dispersion is the continuous phase in which the graft copolymer B is present as discontinuous phase. The aqueous phase of the dispersion is based on water or else a salt in the mixture which contains a light proportion, i.e. at least 20% by weight, of water. The aqueous phase can contain, for example, solvents such as acetone or alcohol, among which ethanol is preferred, in addition to water. In a preferred embodiment, the aqueous phase comprises predominantly water, in particular only water. Apart from the solvents and the polymers, compounds originating from the production process, e.g. emulsifiers, monomer residues or stabilizers which have not been removed, can of course be present in the aqueous phase.

It is in principle unimportant whether the graft copolymer B has firstly been prepared in a separate process and subsequently produced into the aqueous phase or the graft copolymer B is isolated directly from a reaction mixture forming the aqueous phase. However, owing to the simplicity of the process, greatest preference is given to the graft copolymer B being isolated directly from its reaction mixture. For the present purposes, the term graft copolymer B also includes a mixture of various graft copolymers B which are used according to the invention. Thus, for example, the solution, suspension or emulsion of one or more further graft copolymers B or else the further graft copolymer(s) B themselves can be added to the aqueous reaction mixture of a graft copolymer B. The mixture of these graft copolymers B can subsequently be isolated. The graft copolymer B is particularly preferably isolated from its reaction mixture.

According to the invention, an aqueous solution a1) of the components A1) and A2) in the following composition is preferably used as precipitant:
A1) from 0.20 to 0.60% by weight of MgSO₄, and
A2) from 0.02 to 0.10% by weight of sulfuric acid;
   particularly preferably A1) from 0.30 to 0.60% by weight of MgSO₄, and
A2) from 0.03 to 0.08% by weight of sulfuric acid; and
   very particularly preferably A1) from 0.40 to 0.60% by weight of MgSO₄, and
A2) from 0.04 to 0.06% by weight of sulfuric acid,
   in particular A1) 0.40% by weight of MgSO₄, and
A2) 0.05% by weight of sulfuric acid.

According to the invention, an aqueous solution a1) of the components A1) and A3) in the following composition is more preferably used as precipitant:
A1) from 0.20 to 0.60% by weight of MgSO₄, and
A3) from 0.02 to 0.40% by weight of an aluminum salt of sulfuric acid which is soluble in a monodisperse manner in water, preferably Al₂(SO₄)₃;
   particularly preferably A1) from 0.20 to 0.50% by weight of MgSO₄, and
A3) from 0.05 to 0.30% by weight of an aluminum salt of sulfuric acid which is soluble in a monodisperse manner in water, preferably Al₂(SO₄)₃; and
   very particularly preferably A1) from 0.30 to 0.50% by weight of MgSO₄, and
A3) from 0.05 to 0.20% by weight of an aluminum salt of sulfuric acid which is soluble in a monodisperse manner in water, preferably Al₂(SO₄)₃.

According to the invention, an aqueous solution a1) of the components A2) and A3) in the following composition is more preferably used as precipitant:
A2) from 0.02 to 0.10% by weight of sulfuric acid, and
A3) from 0.02 to 0.40% by weight of an aluminum salt of sulfuric acid which is soluble in a monodisperse manner in water, preferably Al₂(SO₄)₃;
   particularly preferably A2) from 0.03 to 0.08% by weight of sulfuric acid, and
A3) from 0.05 to 0.30% by weight of an aluminum salt of sulfuric acid which is soluble in a monodisperse manner in water, preferably Al₂(SO₄)₃; and
   very particularly preferably A2) from 0.04 to 0.06% by weight of sulfuric acid, and
A3) from 0.05 to 0.20% by weight of an aluminum salt of sulfuric acid which is soluble in a monodisperse manner in water, preferably Al₂(SO₄)₃.

According to the invention, an aqueous solution a1) of the components A1), A2) and A3) in the following composition is more preferably used as precipitant:
A1) from 0.10 to 0.40% by weight of MgSO₄,
A2) from 0.02 to 0.08% by weight of sulfuric acid, and
A3) from 0.02 to 0.15% by weight of an aluminum salt of sulfuric acid which is soluble in a monodisperse manner in water, preferably Al₂(SO₄)₃; and
   particularly preferably A1) from 0.10 to 0.30% by weight of MgSO₄,
A2) from 0.03 to 0.06% by weight of sulfuric acid, and
A3) from 0.05 to 0.15% by weight of an aluminum salt of sulfuric acid which is soluble in a monodisperse manner in water, preferably Al₂(SO₄)₃.

Among the abovementioned precipitants, particular preference is given to using an aqueous solution a1) of the components A1) and A2) as described above as precipitant.

In the process of the invention, magnesium sulfate (MgSO₄) is used as MgSO₄×7 hydrate or anhydrous magnesium sulfate.

In the process of the invention, the sulfuric acid can be used as concentrated sulfuric acid.

For the purposes of the present invention, aluminum salts of sulfuric acid which are soluble in a monodisperse manner in water are aluminum salts which give a “true solution” with water. Examples of such aluminum salts are Al₂(SO₄)₃, KAl(SO₄)₂, NaAl(SO₄)₂ or NH₄Al(SO₄)₂, with particular preference being given to Al₂(SO₄)₃. The abovementioned aluminum salts are preferably used as anhydrous aluminum salts in industry; in the laboratory also as the corresponding hydrates.

The components of the precipitant used according to the invention are used as aqueous solution. The aqueous solution comprises the components used according to the invention dissolved in an aqueous solvent, e.g. in water or a water/ethanol mixture, in particular in water. The components are particularly preferably used as a solution in water.

The precipitant can be added all at once, in portions or in a feed stream process with or without profile. The addition is preferably effected discontinuously or, in industry, continuously. The pH of the aqueous phase in which the graft copolymer is present can vary within wide limits. The pH of the aqueous phase after the precipitation is particularly preferably in the range from 4 to 11, for example in the range from 5 to 10. In particular, the pH of the aqueous phase after the precipitation is in the region of 7 if the precipitant used does not contain any component A2); otherwise, in the presence of the component A2), the pH is in the region of 5.

In a particularly preferred embodiment of the invention, the aqueous solution a1) comprising the components of the precipitant is initially charged and the graft copolymer present in the aqueous phase is fed into the initially charged solution of the precipitant.

The amount of precipitant required for the precipitation can vary within wide limits and depends, inter alia, on the concentration of the graft copolymer in the aqueous phase and the auxiliaries such as emulsifiers which are used. In general, the amount of graft copolymer (solid), based on the total aqueous phase, is from 10 to 30% by weight, preferably from 15 to 25% by weight, in particular from 18 to 22% by weight. For the purposes of the present invention, the total aqueous phase is the aqueous phase made up of graft copolymer dispersion and aqueous solution a1) of the precipitant.

The precipitation can be carried out at atmospheric pressure. However, it can also be carried out at a pressure which is below or above this, e.g. in the range from 1 to 10 bar. A pressure in the range from 1 to 5 bar, in particular 4 bar, is advantageous for the process of the invention. The temperature at which the precipitation is carried out can vary within wide limits. Temperatures in the range from 20 to 140° C., preferably from 70 to 100° C., particularly preferably from 80 to 95° C., have been found to be advantageous for the graft copolymers used according to the invention.

During the precipitation, it is advantageous for the aqueous solution to be subjected to shear, for example by stirring. The shear rates depend greatly on the system which is present. The shear rate can also be varied during the course of the precipitation. The precipitation can be carried out in a variety of reactors. Suitable reactors include stirred vessels, cascades of stirred vessels, tube reactors with static mixers and tube reactors with dynamic mixers. The precipitation can be carried out in a batch process or in a continuous process or in a semibatch process. In a discontinuous mode of operation, it is possible to work-up, for example, in stirred vessels. In the case of a continuous procedure in particular, the dispersion of the graft copolymer can be introduced into a flow tube with or without mixing elements. The solution of the precipitant can, for example, be sprayed in.

The process of the invention can comprise further steps or measures for work-up, which are known in principle to those skilled in the art.

The graft copolymer is, after it has been isolated according to the invention, preferably sintered. The sintering operation can be very short, for example take a few seconds or be in the range of minutes. However, it can also be necessary to sinter the graft copolymer over a longer period of time. Thus, the sintering operation can take up to a number of hours. The graft copolymers are often sintered for a period of from one minute to 2 hours. The temperature in the sintering operation is usually in the range from about 70 to 200° C., preferably from 90 to 125° C. During the sintering operation, the temperature can be constant. However, it can also be advantageous to alter the temperature during the sintering step. The pressure during the sintering operation is preferably in the range from 1 to 5 bar.

The precipitated and optionally sintered graft copolymer can, for example, be separated off from the aqueous phase by sieving, pressing, filtration, decantation, sedimentation, preferably centrifugation, or by partial thermal drying. The separation can also be carried out by means of squeezing in an extruder having an appropriate structure which is known per se to those skilled in the art. Of course, the graft copolymer can likewise be separated off from the aqueous phase by a combination of the steps mentioned.

From the graft copolymers obtainable by the process of the invention, it is possible to produce thermoplastic molding compositions which comprise at least one thermoplastic copolymer A, at least one graft copolymer B and optionally further components K in the following composition:
A: from 40 to 80% by weight of at least one thermoplastic copolymer A obtainable from:
   A1: from 20 to 31% by weight, based on the copolymer A, of acrylonitrile,
and
   A2: from 69 to 80% by weight, based on the copolymer A, of styrene or α-methylstyrene or a mixture of styrene and α-methylstyrene,
B: from 20 to 60% by weight of at least one graft copolymer B prepared by the process of the invention;
   and
K: from 0 to 5% by weight of further components K,
   where the sum of A, B and K is 100% by weight.

Preference is given to thermoplastic molding compositions according to the invention comprising (or consisting of):
A: from 50 to 75% by weight of at least one thermoplastic copolymer A obtainable (or obtained) from:
   A1: from 20 to 31% by weight, based on the copolymer A, of acrylonitrile,
and
   A2: from 69 to 80% by weight, based on the copolymer A, of styrene or α-methylstyrene or a mixture of styrene and α-methylstyrene,
B: from 25 to 50% by weight of at least one graft copolymer B prepared by the process of the invention;
   and
K: from 0 to 5% by weight of further components K,
   where the sum of A, B and K is 100% by weight.

Particular preference is given to thermoplastic molding compositions according to the invention comprising (or consisting of):
A: from 55 to 75% by weight of at least one thermoplastic copolymer A obtainable from:
   A1: from 20 to 31% by weight, based on the copolymer A, of acrylonitrile,
and
   A2: from 69 to 80% by weight, based on the copolymer A, of styrene or α-methylstyrene or a mixture of styrene and α-methylstyrene,
B: from 25 to 45% by weight of at least one graft copolymer B prepared by the process of the invention;
   and
K: from 0 to 5% by weight of further components K,
   where the sum of A, B and K is 100% by weight.

### Copolymer A

The copolymer A is preferably prepared from the components acrylonitrile and styrene and/or α-methylstyrene by bulk polymerization or in the presence of one or more solvents. Preference is given to copolymers A having molar masses M_{w} of from 50 000 to 300 000 g/mol, with the molar masses being able to be determined, for example, by light scattering in tetrahydrofuran (GPC with UV detection). The copolymer A forms the matrix of the thermoplastic molding composition.

The copolymer A can, in particular, comprise or consist of:
(Aa) polystyene-acrylonitrile prepared from, based on (Aa), from 69 to 80% by weight of styrene and from 20 to 31% by weight of acrylonitrile, or
(Ab) poly-α-methylstyrene-acrylonitrile prepared from, based on (Ab), from 69 to 80% by weight of α-methylstyrene and from 20 to 31% by weight of acrylonitrile, or
(Ac) a mixture of the copolymer matrix (Aa) and the copolymer matrix (Ab).

The copolymer A can also be obtained by copolymerization of acrylonitrile, styrene and α-methylstyrene. However, it is in principle also possible to use polymer matrices which comprise further monomer building blocks.

The viscosity (Vz) of the copolymeric matrix A is (measured in accordance with DIN 53726 at 25° C. in a 0.5% strength by weight solution in DMF) from, for example, 50 to 120 ml/g. The copolymer matrix A can be prepared by bulk polymerization of solution polymerization in, for example, toluene or ethylbenzene by a process as described, for example, in the Kunststoff-Handbuch, Vieweg-Daumiller, volume V, (Polystyrene), Carl-Hanser-Verlag, Munich 1969, pages 122 ff., lines 12 ff.

As indicated above, the preferred copolymer matrix component A is a polystyrene-acrylonitrile, poly-α-methylstyrene-acrylonitrile or a mixture thereof. In a preferred embodiment of the invention, the component A is, after it has been prepared, isolated by methods known to those skilled in the art and preferably processed to give pellets.

The copolymers A used according to the invention in the molding composition can, for example, also be mixed with further thermoplastic polymers (TP). Possibilities here are, in particular, partially crystalline polyamides, partially aromatic copolyamides, polyesters, polyoxyalkylene, polyarylene sulfides, polyether ketones, polyvinyl chlorides and/or polycarbonates.

The suitable polycarbonates or polyester carbonates can be linear or branched. Branched products are preferably obtained by incorporation of from 0.05 to 2.0 mol %, based on the sum of the diphenols used, of trifunctional compounds or compounds having a functionality of more than three, e.g. those having three or more than three phenolic OH groups. The polycarbonates or polyester carbonates can contain aromatically bound halogen, preferably bromine and/or chlorine. However, they are preferably halogen-free. They have average molecular weights (M_{w}, weight average; determined, for example, by ultracentrifugation or light scattering) of from 10 000 to 200 000, preferably from 20 000 to 80 000.

Suitable thermoplastic polyesters are preferably polyalkylene terephthalates, i.e. reaction products of aromatic dicarboxylic acids or reactive derivatives thereof (e.g. dimethyl esters or anhydrides) and aliphatic, cycloaliphatic or arylaliphatic diols and mixtures of such reaction products. Preferred polyalkylene terephthalates can be prepared from terephthalic acids (or reactive derivatives thereof) and aliphatic or cycloaliphatic diols having from 2 to 10 carbon atoms by known methods (see Kunststoff-Handbuch, volume VIII. p. 695 ff, Carl Hanser Verlag, Munich 1973). In preferred polyalkylene terephthalates, from 80 to 100 mol %, and preferably from 90 to 100 mol %, of the dicarboxylic acid radicals are terephthalic acid radicals and from 80 to 100 mol %, preferably from 90 to 100 mol %, of the diol radicals are ethylene glycol and/or 1,4-butanediol radicals. The polyalkylene terephthalates can, in addition to ethylene glycol or 1,4-butanediol radicals, contain from 0 to 20 mol % of radicals of other aliphatic diols having from 3 to 12 carbon atoms or cycloaliphatic diols having from 6 to 12 carbon atoms (see, for example, DE 2 407 647, DE 2 407 776 and DE 2715 932). The polyalkylene terephthalates can be branched by incorporation of relatively small amounts of trihydric or tetrahydric alcohols or tribasic or tetrabasic carboxylic acids, as are described in DE 1 900 270 and U.S. Pat. No. 3,692,744.

Examples of preferred branching agents are trimesic acid, trimellitic acid, trimethylolethane and trimethylolpropane and pentaerythritol. It is advisable to use not more than 1 mol % of the branching agent, based on the acid component. Preference is given to polyalkylene terephthalates which are prepared solely from terephthalic acid and reacted derivatives thereof (e.g. dialkyl esters thereof) and ethylene glycol and/or 1,4-butanediol, and mixtures of these polyalkylene terephthalates. Preferred polyalkylene terephthalates also include copolyesters which have been prepared from at least two of the abovementioned alkyl components: particularly preferred copolyesters are poly(ethylene glycol-1,4-butanediol) terephthalates.

Suitable polyamides are known homopolyamides, copolyamides and mixtures of these polyamides. They can be partially crystalline and/or amorphous polyamides. Suitable partially crystalline polyamides are polyamide-6, polyamide-6,6, mixtures and corresponding copolymers of these components. Further possibilities are partially crystalline polyamides whose acid component consists entirely or partly of terephthalic acid and/or isophthalic acid and/or suberic acid and/or sebacic acid and/or azelaic acid and/or adipic acid and/or cyclohexanedicarboxylic acid, whose diamine component consists entirely or partly of m- and/or p-xylylenediamine and/or hexamethylenediamine and/or 2,2,4-trimethylhexamethylenediamine and/or 2,2,4-trimethylhexamethylenediamine and/or isophoronediamine and whose composition is known. Mention may also be made of polyamides which are prepared entirely or partly from lactams having 7-12 carbon atoms in the ring, optionally with concomitant use of one or more of the abovementioned starting components.

As amorphous polyamides, it is possible to use known products which are obtained by polycondensation of diamines such as ethylenediamine, hexamethylenediamine, decamethylenediamine, 2,2,4- and/or 2,4,4-trimethylhexamethylenediamine, m- and/or p-xylylenediamine, bis(4-aminocyclohexyl)methane, bis(4-aminocyclohexyl)-propane, 3,3′-dimethyl-4,4′-diaminodicyclohexylmethane, 3-aminomethyl,3,5,5-trimethylcyclohexylamine, 2,5- and/or 2,6-bis(aminomethyl)norbornane and/or 1,4-Diaminomethylcyclohexane with dicarboxylic acids such as oxalic acid, adipic acid, azelaic acid, decanedicarboxylic acid, heptadecanedicarboxylic acid, 2,2,4- and/or 2,4,4-trimethyladipic acid, isophthalic acid and terephthalic acid.

Copolymers obtained by polycondensation of a plurality of monomers are also suitable, as are copolymers prepared with addition of aminocarboxylic acids such as ε-aminocaproic acid, ω-aminoundecanoic acid or ω-aminolauric acid or lactams thereof. Particularly suitable amorphous polyamides are polyamides prepared from isophthalic acid, hexamethylenediamine and further diamines such as 4,4′-diaminodicyclohexylmethane, isophoronediamine, 2,2,4- and/or 2,4,4-tri-methylhexamethylenediamine, 2,5- and/or 2,6-bis(aminomethyl)norbornane; or from isophthalic acid, 4,4′-diaminodicyclohexylmethane and ε-caprolactam; or from isophthalic acid, 3,3′-dimethyl-4,4′-diaminodicyclohexylmethane and laurolactam; or from terephthalic acid and the isomer mixture of 2,2,4- and/or 2,4,4-trimethylhexamethylenediamine.

It is also possible to use mixtures of two or more of the polymers (TP) mentioned. The thermoplastic molding compositions of the invention can comprise, based on the amount of copolymer A plus graft copolymer B, from 0 to 90% by weight, preferably from 0 to 50% by weight, particularly preferably from 0 to 20% by weight, of the abovementioned polymers (TP).

If at least one of the abovementioned polymers (TP) is present in the thermoplastic molding composition, the minimum proportion of this is usually 0.1% by weight.

Preference is given to thermoplastic molding compositions consisting of copolymer A and graft copolymer B and optionally further components K.

As further components (K), the thermoplastic molding composition can comprise one or more components selected from the group consisting of dispersants (DM), fillers (F) and additives (D).

If the component (K) is present, it is often used in amounts of from 0.01 to 5% by weight, preferably in amounts of from 0.05 to 5% by weight, particularly preferably from 0.1 to 5% by weight.

If the component (K) is present, the abovementioned thermoplastic molding compositions according to the invention often have the following composition:
A: from 40 to 79.99% by weight of at least one thermoplastic copolymer A obtainable from:
   A1: from 20 to 31% by weight, based on the copolymer A, of acrylonitrile,
and
   A2: from 69 to 80% by weight, based on the copolymer A, of styrene or α-methylstyrene or a mixture of styrene and α-methylstyrene,
B: from 20 to 59.99% by weight of at least one graft copolymer B prepared by the process of the invention;
   and
K: from 0.01 to 5% by weight of further components K,
   where the sum of A, B and K is 100% by weight.

If the component (K) is present, preference is given to thermoplastic molding compositions according to the invention comprising (or consisting of):
A: from 50 to 74.95% by weight of at least one thermoplastic copolymer A obtainable from:
   A1: from 20 to 31% by weight, based on the copolymer A, of acrylonitrile, and
   A2: from 69 to 80% by weight, based on the copolymer A, of styrene or α-methylstyrene or a mixture of styrene and α-methylstyrene,
B: from 25 to 49.95% by weight of at least one graft copolymer B prepared by the process of the invention; and
K: from 0.05 to 5% by weight of further components K,
   where the sum of A, B and K is 100% by weight.

If the component (K) is present, particular preference is given to thermoplastic molding compositions according to the invention comprising (or consisting of):
A: from 55 to 74.9% by weight of at least one thermoplastic copolymer A obtainable from:
   A1: from 20 to 31% by weight, based on the copolymer A, of acrylonitrile, and
   A2: from 69 to 80% by weight, based on the copolymer A, of styrene or α-methylstyrene or a mixture of styrene and α-methylstyrene,
B: from 25 to 44.9% by weight of at least one graft copolymer B prepared by the process of the invention;
   and
K: from 0.1 to 5% by weight of further components K,
   where the sum of A, B and K is 100% by weight.

As component K, the thermoplastic molding compositions can also contain from 0 to 5% by weight, often from 0.1 to 5% by weight, of fibrous or particulate filters (F) or mixtures thereof, in each case based on the amount of the components A plus B plus K. For example, glass fibers, which can be provided with a size and a bonding agent, glass spheres, mineral fibers, aluminum oxide fibers, mica, quartz flour or wollastonite can be added as fillers or reinforcing materials. In addition, metal flocs, metal powders, metal fibers, metal-coated fillers, e.g. nickel-glass coated fibers, and also other aggregates which shield from electromagnetic waves can be mixed into the molding compositions of the invention. In addition, carbon fibers, carbon black, in particular conductor carbon black, or nickel-coated carbon fibers can be added.

As auxiliaries and processing additives, various additives (D) can be added in amounts of from 0 to 5% by weight, often from 0.1 to 5% by weight, to the molding compositions. Possible additives (D) are all substances which are customarily employed for processing or finishing of the polymers.

Mention may be made by way of example of dyes, pigments, colorants, antistatics, antioxidants, stabilizers for improving the thermal stability, stabilizers for increasing the light stability, stabilizers to increase the hydrolysis resistance and the resistance to chemicals, agents against thermal decomposition and in particular lubricants/sliding agents which are advantageous for producing moldings or shaped parts. These further additives can be introduced at any stage of the production process, but preferably at an early point in time in order to make early use of the stabilizing effects (or other specific effects) of the additive. As regards further conventional auxiliaries and additives, reference may be made, for example, to “Plastics Additives Handbook”, edited by Gächter and Müller, 4th edition, Hanser Publ., Munich, 1996.

Suitable pigments are, for example, titanium dioxide, phthalocyanines, ultramarine blue, iron oxides or carbon black, and also the entire class of organic pigments.

Suitable colorants are, for example, all dyes which can be used for transparent, semitransparent or opaque coloration of polymers, in particular those which are suitable for coloring styrene copolymers.

As suitable flame retardants, it is possible to use, for example, the halogen-containing or phosphorus-containing compounds known to those skilled in the art, magnesium hydroxide and also other customary compounds, or mixtures thereof.

Suitable antioxidants are, for example, sterically hindered monocyclic or polycyclic phenolic antioxidants which can be substituted in various ways and also be bridged via substituents. These include not only monomeric compounds but also oligomeric compounds which can be made up of a plurality of phenolic base molecules. Further possibilities are hydroquinones and substituted compounds analogous to hydroquinone, likewise antioxidants based on tocopherols and derivatives thereof. Mixtures of various antioxidants can also be used. It is in principle possible to use all commercially available compounds or compounds suitable for styrene copolymers, e.g. antioxidants of the Irganox series. Together with the phenolic antioxidants which have been mentioned by way of example above, it is possible to make concomitant use of costabilizers, in particular phosphorus- or sulfur-containing costabilizers. Such P- or S-containing costabilizers are known to those skilled in the art.

Suitable stabilizers against the action of light are, for example, various substituted resorcinols, salicylates, benzotriazoles and benzophenones. Possible matting agents are both inorganic materials such as talc, glass spheres or metal carbonates (e.g. MgCO₃, CaCO₃) and also polymer particles, in particular spherical particles having diameters d₅₀ above 1 mm, based on, for example, methyl methacrylate, styrene compounds, acrylonitrile or mixtures thereof. Polymers which comprise acidic or basic monomers in copolymerized form can also be used.

Suitable antidripping agents are, for example, polytetrafluoroethylene (Teflon) polymers and ultrahigh molecular weight polystyrene (molar mass M_{W} above 2 000 000).

As examples of fibrous or pulverulent fillers, mention may be made of carbon fibers or glass fibers in the form of woven glass fabrics, glass mats or glass silk rovings, chopped glass, glass spheres and wollastonite, particularly preferably glass fibers. When glass fibers are used, these can be coated with a size and a bonding agent to make them more compatible with the blend components.

The glass fibers can be incorporated either in the form of short glass fibers or in the form of continuous strands (rovings).

Suitable particulate fillers are, for example, carbon black, amorphous silica, magnesium carbonate, powdered quartz, mica, bentonites, talc, feldspar or in particular calcium silicates such as wollastonite and kaolin.

Suitable antistatics are, for example, amine derivatives such as N,N-bis(hydroxy-alkyl)alkylamines or N,N-bis(hydroxyalkyl)alkyleneamines, polyethylene glycol esters, copolymers of ethylene oxide glycol and propylene oxide glycol (in particular two-block or three-block copolymers composed of ethylene oxide blocks and propylene oxide blocks) and glyceryl monostearates and distearates, and also mixtures thereof.

Suitable stabilizers are, for example, hindered phenols and also vitamin E or compounds having an analogous structure, e.g. butylated condensation products of p-cresol and cyclopentadiene. HALS (hindered amine light stabilizers), benzophenones, resorcinols, salicylates, benzotriazoles are also suitable. Other suitable compounds are, for example, thiocarboxylic esters. It is also possible to use C₆-C₂₀-alkyl esters of thiopropionoic acid, in particular the stearyl ester and lauryl ester. The dilauryl ester of thiodipropionoic acid (dilauryl thiodipropionate), the distearyl ester of thiodipropionoic acid (distearyl thiodipropionate) or mixtures thereof can also be used. Examples of further additives are HALS absorbers such as bis(2,2,6,6-tetramethyl-4-piperidyl) sebacate or UV absorbers such as 2H-benzotriazol-2-yl(4-methylphenol). Such additives are usually employed in amounts of from 0.01 up to 2% by weight (based on the total mixture).

Suitable lubricants and mold release agents are stearic acids, stearyl alcohol, stearic esters, amide waxes (bisstearylamide), polyolefin waxes and higher fatty acids in general, derivatives thereof and corresponding fatty acid mixtures having from 12 to 30 carbon atoms. Ethylenebisstearamide (e.g. Irgawax, manufactured by Ciba, Switzerland) is also particularly suitable.

The amount of these additives are in the range from 0.05 to 5% by weight.

Silicone oils, oligomeric isobutylene or similar materials are also possible as additives. The normal amounts, if used, are from 0.001 to 3% by weight, based on the amount of the components A plus B plus K. It is also possible to use pigments, dyes, color brighteners such as ultramarine blue, phthalocyanines, titanium dioxide, cadmium sulfides, derivatives of perylenetetracarboxylic acid. Processing aids and stabilizers such as UV stabilizers, heat stabilizers (e.g. butylated reaction products of p-cresol and dicyclopentadiene; Wingstay L; manufacturer: Omnova; or dilauryl thiodipropionate, Irganox PS 800, manufacturer: BASF), lubricants and antistatic (e.g. ethylene oxide-propylene oxide copolymers such as Pluronic (manufacturer: BASF) are, if used, normally employed in amounts of from 0.01 to 5% by weight, based on the total molding composition.

The individual additives are generally used in the amounts customary in each case.

The production of the molding compositions composed of the components A and B (and optionally further polymers (TP) and components K such as fillers (F) and also customary additives (D)) can be carried out by all known methods. However, the blending of the components is preferably carried out by melt mixing, for example joint extrusion, kneading or roll-milling of the components. This is carried out at temperatures in the range from 160 to 400° C., preferably from 180 to 280° C. In a preferred embodiment, the component (B) is partially or completely isolated beforehand from the aqueous dispersion obtained in the respective production steps. For example, the graft copolymers B can be mixed as moist or dry crumbs/powders (for example with a residual moisture content of from 1 to 40%, in particular from 20 to 40%) with the matrix polymers, with complete drying of the graft copolymers then occurring during mixing. The drying of the particles can also be carried out as described in DE-A 19907136.

The graft copolymers prepared by the process of the invention are, in particular, substantially gel-free and can be dried easily and quickly. The molding compositions obtainable from the graft copolymers can be processed by means of the known processes of thermoplastics processing to give moldings; in particular, production of the moldings can be carried out by thermoforming, extrusion, injection molding, calendering, blow molding, pressing, press sintering, deep drawing or sintering, preferably by injection molding.

The abovementioned moldings can in principle be used in all industrial fields. Their range of uses can, for example, extend from the medical or sanitary sector through vehicle construction to consumer goods in the leisure sector or in the household. Moldings produced using the graft copolymers prepared according to the invention display good mechanical properties. In particular, they have surfaces which contain few or no surface defects and have a high surface gloss. Furthermore, they display barely any tendency to undergo yellowing and have good heat resistance and weathering stability. Transparent moldings produced using the graft copolymers prepared according to the invention also have only a low tendency to clouding.

The invention is illustrated by the following examples and claims:

Firstly, the methods used for characterizing the polymers will be briefly summarized:

a) Charpy Notched Impact Toughness [kJ/m²]:

The notched impact toughness is determined on test specimens (80×10×4 mm, produced by injection molding at a melt temperature of 240° C. and a tool temperature of 70° C.), at 23° C. in accordance with ISO 179-1A

b) Flowability (MVR [ml/10 Min]):

The flowability is determined on a polymer melt at 220° C. under a load of 10 kg in accordance with ISO 1133.

c) Particle Size [nm]:

The weight average particle size d_{w} of the rubber dispersions of the graft base B1 was measured using a disk centrifuge DC 24000 from CPS Instruments Inc. The measurement was carried out in 17.1 ml of an aqueous sugar solution having a sucrose density gradient from 8 to 20% by weight in order to achieve stable flotation behavior of the particles. A polybutadiene latex having a narrow distribution and an average particle size of 405 nm was used for calibration. The measurements were carried out at a speed of rotation of the disk of 24 000 rpm by injection of 0.1 ml of a diluted rubber dispersion (aqueous 24% strength by weight sucrose solution containing about 0.2-2% by weight of rubber particles) into the disk centrifuge containing the aqueous sugar solution having a sucrose density gradient from 8 to 20% by weight.

The calculation of the weight average particle size d_{w} and the weight average particle diameter d₅₀, and also d₁₀ and d₉₀ was carried out by means of the formula:

d_{w}=total(nᵢ*dᵢ⁴)/total(nᵢ*dᵢ³)

nᵢ: number of particles having the diameter dᵢ)

The solids contents were measured after dying of the samples at 180° C. for 25 minutes in a drying oven.

### d) Surface Gloss

To determine the surface gloss, rectangular plates having the dimensions 60 mm×40 mm×2 mm are produced from the polymer melt by means of an injection molding machine at a melt temperature of 240° C. and a tool temperature of 70° C. The surface gloss is measured by reflection measurement in accordance with DIN 67530 at an angle of 20°

### e) Yellowness Index YI

The determination of the YI value was carried out on plates having the dimensions 60×40×2 mm produced by injection molding at a melt temperature of 240° C. and a tool temperature of 70° C. by means of the ASTM method E313-96 (light type/observer combination)C/2°.

### EXAMPLES

### Graft Base B1

The preparation of the graft base B1-V (not used according to the invention) is carried out by emulsion polymerization using the feed stream process. 7% by weight of styrene are used as comonomer.

The emulsion polymerization is carried out at a temperature of 67° C. in a 150 l reactor. 43 120 g of the monomer mixture (butadiene and styrene) are polymerized at 67° C. in the presence of 431.2 g of tert-dodecyl mercaptan (TDM), 311 g of potassium stearate, 82 g of potassium persulfate, 147 g of sodium hydrogencarbonate and 58 400 g of water, giving a latex of the graft base having a solids content of 42.1% by weight are introduced into the reactor in the following order: styrene is firstly added in an amount of 7% by weight, based on the total amount of monomers, over a period of 20 minutes. After addition of the styrene, a first part of the butadiene is added in an amount of 7% by weight, based on the total amount of monomers, over a period of 25 minutes. The remaining part of the butadiene, which corresponds to 86% by weight, based on the total amount of monomers, is subsequently added over a period of 8.5 hours. TDM is added all at once at the beginning of the reaction. The conversion is ≧95%.

The preparation of the graft base B1-2 (used according to the invention) is carried out by emulsion polymerization using the feed stream process. 14% by weight of styrene are used as comonomer.

The emulsion polymerization is carried out at a temperature of 67° C. in a 150 l reactor. 43 120 g of the monomer mixture (butadiene and styrene) are polymerized at 67° C. in the presence of 431.2 g of tert-dodecyl mercaptan (TDM), 311 g of potassium stearate, 82 g of potassium persulfate, 147 g of sodium hydrogencarbonate and 58 400 g of water, giving a latex of the graft base having a solids content of 42.1% by weight.

The monomers are introduced into the reactor in the following order:

styrene is firstly added in an amount of 7% by weight, based on the total amount of monomers, over a period of 20 minutes. After the addition of styrene, a mixture of 0.527% by weight of styrene and 6.473% by weight of butadiene, based on the total amount of monomers, is added over a period of 25 minutes.

A mixture of 6.473% by weight of styrene and 79.527% by weight of butadiene, based on the total amount of monomers, is then added over a period of 8.5 hours. TDM is added all at once at the beginning of the reaction. The conversion is ≧95%.

Further data for the graft base B1-V and B1-2 are shown in table 1. The total styrene content is the total amount of styrene, based on the total amount of monomer; the core styrene content relates to the styrene polymerized first, and in all experiments is 7% by weight, based on the total amount of monomers.

TABLE 1

| Graft base | | B1-V | B1-2 |
|---|---|---|---|
| Total styrene content | % by weight | 7 | 14 |
| Core styrene content | % by weight | 7 | 7 |
| Gel content | % by weight | 78.9 | 72.2 |
| QI | | 22 | 29 |
| d_{w} | nm | 88.4 | 104.0 |
| d₁₀ | nm | 72.3 | 90.5 |
| d₅₀ | nm | 90.0 | 105.8 |
| d₉₀ | nm | 101.1 | 114.8 |
| U | | 0.32 | 0.23 |

### Copolymer C-1 Having an Agglomerating Action

The preparation of the copolymer C-1 is carried out by means of emulsion polymerization.

6.29 g of Mersolat H95 (Lanxess Deutschland GmbH, emulsifier, C₁₂-C₁₈—SO₃⁻ K⁺) are firstly dissolved in 1177.2 g of demineralized water and heated to 60° C. in a nitrogen atmosphere while stirring.

While continuing to stir, 4.87 g of potassium persulfate dissolved in 209.2 g of demineralized water are added to this solution. After 15 minutes, 211.2 g of ethyl acrylate are introduced over a period of 18 minutes, with the temperature increasing from 60 to 80° C. at the same time. The following three feed streams are then introduced over a period of 405 minutes:
a) 1691.3 g of ethyl acrylate
b) 3.98 g of potassium persulfate dissolved in 170.9 g of demineralized water
c) solution of 32.95 g of Mersolat H95 (Lanxess Deutschland GmbH) and 90.6 g of methacrylamide in 1248.8 g of demineralized water.

After introduction of the feed streams a-c) is complete, the polymerization is continued for 60 minutes at 80° C. while stirring. The mixture is then cooled to room temperature and 150.9 g of demineralized water are added. The solids content of the latex of the copolymer C1 having an agglomerating action is 40.8% by weight.

### Further Data for the Copolymer C-1:

| Copolymer | | C-1 |
|---|---|---|
| d_{w} | nm | 127.0 |
| d₁₀ | nm | 110.6 |
| d₅₀ | nm | 128.9 |
| d₉₀ | nm | 140.8 |
| U | | 0.238 |

### Agglomerated Graft Base B1

### General Procedure:

59 parts by weight of the latex of the graft base B1, based on the solids content of the latex, are firstly placed in a reaction vessel at a temperature of 68° C. and stirred. 1.357 parts by weight of the latex of the copolymer C having an agglomerating action (based on solids in the latex) are diluted with 10.24 parts by weight of demineralized water. This diluted latex is then added to the graft base B1 over a period of 25 minutes with stirring to effect agglomeration. After 5 minutes, 0.56 part by weight of potassium stearate dissolved in 40.98 parts by weight of demineralized water at 68° C. are added to the agglomerated latex of the graft base B1 while continuing to stir.

The particle size distribution of the agglomerated graft base B1 is measured. Only a fraction of the particles in the latex of the graft base B1 are agglomerated to form larger particles. The agglomeration yield is the proportion of agglomerated particles in % by weight based on the total amount of the particles. The agglomeration yield is determined from the cumulated distribution curve of the particle size measurement. The weight average particle size d₅₀ and the polydispersity U of the particle size distribution of the agglomerated particles (=fraction y) in the resulting agglomerated latex of the graft base B is determined.

Table 2 shows the values determined.

TABLE 2
Agglomerated graft base

| Example (according to the invention) | | x |
|---|---|---|
| Comparative example | x | |
| Graft base B1 | B1-V | B1-2 |
| Agglomeration yield | 65.8 | 64.3 |
| (% by weight) | | |
| d₅₀ (nm) of fraction y | 386 | 390 |
| U of fraction y | 0.23 | 0.24 |

Graft copolymer B

### General Procedure:

After the agglomeration step is complete, 0.074 parts by weight of potassium persulfate dissolved in 3.13 parts by weight of demineralized water is added to the agglomerated latex of the graft base B1 at 68° C. while continuing to stir. A monomer mixture of 32.8 parts by weight of styrene and 8.2 parts by weight of acrylonitrile is added over a period of 2 hours and 44 minutes while continuing to stir.

During the time of introduction of the styrene/acrylonitrile mixture, the temperature is increased to 80° C. After the introduction of the styrene/acrylonitrile mixture is complete, 0.074 parts by weight of potassium persulfate dissolved in 3.13 parts by weight of demineralized water is added while continuing to stir. The polymerization is continued at 80° C. for 80 minutes and the resulting latex of the graft copolymer B is cooled to ambient temperature.

0.37 parts by weight of a dispersion of a stabilizer (based on solids of the dispersion having a solids content of 60% by weight) is added to the graft latex obtained. The dispersion of the graft copolymer is subsequently precipitated by means of an aqueous solution of a precipitant in a steam-heated precipitation vessel provided with stirrer at 4 bar and at a temperature of 88° C. To effect the precipitation, the aqueous solution of the precipitant is placed in the steam-heated precipitation vessel and, after a temperature of 88° C. is attained, the dispersion of the graft copolymer is slowly introduced while stirring. After all components had been added, the respective reactor mixture had the following composition:

0.40% by Weight of MgSO₄ and 0.10% by Weight of Al₂(SO₄)₃ (According to the Invention)

| | | |
|---|---|---|
| Deionized water | 12 996 | g |
| MgSO₄*7H₂O | 156.6 | g |
| Sulfuric acid (50% strength) | 0 | g |
| Graft copolymer dispersion (42% solids content) | 11 905 | g |
| Al₂(SO₄)₃*18 H₂O | 39.1 | g |

### 0.80% by Weight of MgSO₄ (Comparison)

| | | |
|---|---|---|
| Deionized water | 12 928 | g |
| MgSO₄*7H₂O | 327.6 | g |
| Sulfuric acid (50% strength) | 0 | g |
| Graft copolymer dispersion (42% solids content) | 11 905 | g |
| Al₂(SO₄)₃*18 H₂O | 0 | g |

0.50% by Weight of Al₂(SO₄)₃ (Comparison)

| | | |
|---|---|---|
| Deionized water | 12 995 | g |
| MgSO₄*7H₂O | 0 | g |
| Sulfuric acid (50% strength) | 0 | g |
| Graft copolymer dispersion (42% solids content) | 11 905 | g |
| Al₂(SO₄)₃*18 H₂O | 195.7 | g |

0.60% by Weight of MgSO₄ and 0.05% by Weight of H₂SO₄ (According to the Invention)

| | | |
|---|---|---|
| Deionized water | 12 960 | g |
| MgSO₄*7H₂O | 245.7 | g |
| Sulfuric acid (50% strength) | 20 | g |
| Graft copolymer dispersion (42% solids content) | 11 905 | g |
| Al₂(SO₄)₃*18 H₂O | 0 | g |

0.40% by Weight of MgSO₄ and 0.05% by Weight of H₂SO₄ (According to the Invention)

| | | |
|---|---|---|
| Deionized water | 13 001 | g |
| MgSO₄*7H₂O | 163.8 | g |
| Sulfuric acid (50% strength) | 20 | g |
| Graft copolymer dispersion (42% solids content) | 11 905 | g |
| Al₂(SO₄)3*18 H₂O | 0 | g |

The precipitation suspension is then transferred to a steam-heated sintering vessel provided with a stirrer. Sintering is carried out at 4 bar and 116° C. for 60 minutes. The sintered graft copolymer is subsequently centrifuged in a centrifuge, and washed twice with 550 parts by weight of demineralized water. The polymer which has been worked up in this way is processed further at a residual moisture content of from 15 to 30% by means of extrusion.

### Thermoplastic Copolymer A

SAN Polymer: Luran VLN, random copolymer of styrene and acrylonitrile having an acrylonitrile content of 24% by weight and having an Mw of 120 000 g/mol, a viscosity number of 67 ml/g (concentration of 5 g/l in dimethylformamide measured at 20° C.) and a melt flow rate MVR of 64 [ml/10 min], measured at 220° C. and a load of 10 kg in accordance with ISO 1133.

### Additives

Stabilizer masterbatch comprising thermal and light stabilizers, e.g. Tinuvin 770, Cyasorb 3853, Chimasorb 944 in SAN polymer (Luran VLN)

### Thermoplastic Molding Compositions Composed of SAN Polymer a and Graft Copolymer B

The abovementioned SAN polymer A and the graft copolymer B are mixed in the proportions (based on the total molding composition) indicated in the respective table with addition of 1% by weight of the abovementioned stabilizer masterbatch in a twin-screw extruder having a screw diameter of 25 mm. In the extrusion zone, the temperature was set to from 200 to 250° C. and processing was carried out at 700 rpm of the twin-screw extruder. The batch size for all examples was 4 kg. Tests to determine the flowability (MVR), the Charpy notched impact toughness, the yellowness index (YI) and the surface gloss were carried out on the ABS molding compositions obtained. The test methods indicated above were employed here. Tables 3 and 4 summarize the test results for the ABS molding compositions examined.

TABLE 3

| | | | | 0.40% by weight of | | | | | |
|---|---|---|---|---|---|---|---|---|---|
| | | | | MgSO₄ + | | | | | |
| | 0.80% by weight of | | | 0.10% by weight of | | | 0.50% by weight of | | |
| Precipitant | MgSO₄ | | | Al₂(SO₄)₃ | | | Al₂(SO₄)₃ | | |
| Graft | 35.2 | 37.0 | 39.2 | 33.0 | 34.6 | 36.8 | 31.0 | 33.9 | 35.6 |
| copolymer | | | | | | | | | |
| B-2 (% by | | | | | | | | | |
| weight) | | | | | | | | | |
| SAN copolymer | 63.8 | 62.0 | 59.8 | 64.0 | 64.4 | 62.2 | 68.0 | 65.1 | 63.4 |
| (% by weight) | | | | | | | | | |
| Charpy ak [kJ/m²] | 29.3 | 31 | 31.1 | 23 | 28.1 | 31.1 | 25.1 | 29.4 | 31.5 |
| MVR [ml/10 min] | 13.76 | 12.03 | 10.67 | 16.49 | 13.55 | 11.78 | 15.60 | 13.50 | 11.40 |
| Yellowness index | 25.19 | 25.72 | 25.99 | 29.67 | 30.65 | 30.94 | 34.87 | 34.11 | 32.91 |

| | | | |
|---|---|---|---|
| Al content of | below detection | 0.025 | 0.263 |
| precipitation | limit | | |
| solution | | | |
| [%] | | | |

The MgSO₄/Al₂(SO₄)₃ precipitant used according to the invention is very efficient since relatively small amounts of salts are necessary to achieve equally high yields of the graft copolymer B. In addition, the ABS molding compositions containing the graft copolymer obtained by the process of the invention which were examined have the same notched impact toughness and an improved yellowness index compared to a pure Al₂(SO₄)₃ solution of the same salt concentration (table 3).

Table 4 shows studies on corresponding molding compositions composed of an SAN polymer A and a graft copolymer B, using the graft copolymer B-2 (with graft base B1-2) as graft copolymer B according to the invention and the graft copolymer B-V (with graft base B1-V) as comparison.

TABLE 4

| | 0.60% by weight of | 0.60% by weight of | 0.40% by weight of | 0.40% by weight of |
|---|---|---|---|---|
| | MgSO₄ and 0.05% by | MgSO₄ and 0.05% by | MgSO₄ and 0.05% by | MgSO₄ and 0.05% by |
| Precipitant | weight of H₂SO₄ | weight of H₂SO₄ | weight of H₂SO₄ | weight of H₂SO₄ |
| Graft copolymer | 31.1 | 33.9 | 30.1 | 31.7 |
| (% by weight) | | | | |
| SAN copolymer | 67.9 | 65.1 | 68.9 | 67.3 |
| (% by weight) | | | | |
| Gloss at 20° | 87.5 | 80.6 | 88.3 | 75.9 |
| Yellowness | 20.3 | 33.22 | 24.47 | 32.16 |
| index | | | | |
| MVR | 19.23 | 12.87 | 19.11 | 15.83 |
| [ml/10 min] | | | | |
| Graft copolymer | B-2 | B-V | B-2 | B-V |

Table 4 shows that the use of the MgSO₄/H₂SO₄ precipitant claimed leads to graft copolymers and ABS molding compositions produced therefrom which display a significantly improved yellowness index and surface gloss provided that, as the comparison impressively shows, the graft copolymer is a graft copolymer having a styrene-rich graft base, as claimed in the process of the invention.

1-15. (canceled)

16. A process for preparing ABS graft copolymers, which comprises a step for isolating the graft copolymer B present in an aqueous dispersion by means of a precipitant, wherein an aqueous solution a1) of the components A1) and A2); A1) and A3); A2) and A3); or A1), A2) and A3) is used as precipitant:
A1) from 0.20 to 0.60% by weight of MgSO₄, based on the total amount of water, and
A2) from 0.02 to 0.10% by weight of sulfuric acid, based on the total amount of water,
where the amount of A1) is greater than the amount of A2); or
A1) from 0.1 to 0.65% by weight of MgSO₄, based on the total amount of water, and
A3) from 0.01 to 0.40% by weight, based on the total amount of water, of an aluminum salt of sulfuric acid which is soluble in a monodisperse manner in water,
where the amount of A1) is greater than the amount of A3); or
A2) from 0.01 to 0.20% by weight of sulfuric acid, based on the total amount of water, and
A3) from 0.01 to 0.40% by weight, based on the total amount of water, of an aluminum salt of sulfuric acid which is soluble in a monodisperse manner in water; or
A1) from 0.10 to 0.40% by weight of MgSO₄, based on the total amount of water,
A2) from 0.01 to 0.10% by weight of sulfuric acid, based on the total amount of water, and
A3) from 0.01 to 0.20% by weight, based on the total amount of water, of an aluminum salt of sulfuric acid which is soluble in a monodisperse manner in water,
where the amount of A1) is greater than the amount of A3) and the amount of A3) is greater than the amount of A2);
where the process does not comprise any further steps for isolation or for work-up in the presence of salts and/or acids;
and where the graft copolymer B has a bimodal particle size distribution and is made up of:
B1: from 40 to 85% by weight, based on the solids content of the graft copolymer B, of a graft base (B1) obtainable by (a) polymerization of:
(B11): from 10.5 to 24.5% by weight, based on the graft base B1, of at least one vinylaromatic, in particular styrene, and
(B12): from 75.5 to 89.5% by weight, based on the graft base B1, of at least one diene, in particular butadiene,
where (B11) and (B12) make up 100% by weight of B1;
and
B2: from 15 to 60% by weight, based on the solids content of the graft copolymer B, of a graft shell obtainable by reaction of the graft base B1 with a mixture of:
(B21) from 70 to 90% by weight, based on the graft shell (B2), of styrene and/or α-methylstyrene, in particular styrene, and
(B22) from 10 to 30% by weight, based on the graft shell (B2), of acrylonitrile and/or methyl methacrylate, in particular acrylonitrile,
where the total sum of graft base B1 and graft shell B2 makes up 100% by weight of B and the solids content of the graft copolymer in the aqueous dispersion is from 20 to 60% by weight.

17. The process as claimed in claim 16, characterized in that an aqueous solution a1) of the components A1) and A2) in the following composition is used as precipitant:
A1) from 0.30 to 0.60% by weight of MgSO₄, and
A2) from 0.03 to 0.08% by weight of sulfuric acid.

18. The process as claimed in claim 16, characterized in that an aqueous solution a1) of the components A1) and A3) in the following composition is used as precipitant:
A1) from 0.40 to 0.60% by weight of MgSO₄, and
A3) from 0.04 to 0.06% by weight of an aluminum salt of sulfuric acid which is soluble in a monodisperse manner in water.

19. The process as claimed in claim 16, characterized in that an aqueous solution a1) of the components A1) and A2) in the following composition is used as precipitant:
A1) from 0.20 to 0.60% by weight of MgSO₄, and
A2) from 0.02 to 0.40% by weight of sulfuric acid.

20. The process as claimed in claim 16, characterized in that an aqueous solution a1) of the components A1) and A3) in the following composition is used as precipitant:
A1) from 0.2 to 0.50% by weight of MgSO₄, and
A3) from 0.05 to 0.30% by weight of an aluminum salt of sulfuric acid which is soluble in a monodisperse manner in water.

21. The process as claimed in claim 16, characterized in that the aqueous phase of the dispersion of the graft copolymer and the aqueous solvent of the aqueous solution of the precipitant a1) comprises only water as solvent.

22. The process as claimed in claim 16, characterized in that the process is carried out in a batch process or in a continuous process or in a semibatch process.

23. The process as claimed in claim 16, characterized in that it is carried out at a pressure in the range from 1 to 10 bar, and at temperatures in the range from 80 to 100° C.

24. The process as claimed in claim 16, characterized in that the aqueous solution a1) of the precipitant is initially charged and the graft copolymer present in an aqueous phase is introduced with stirring.

25. The process as claimed in claim 22, characterized in that it is carried out at a pressure above atmospheric pressure.

26. The process of claim 16, wherein the aluminum salt of sulfuric acid which is soluble in a monodisperse manner in water is Al₂(SO₄)₃.

27. The process of 18, wherein the aluminum salt of sulfuric acid which is soluble in a monodisperse manner in water is Al₂(SO₄)₃.

28. The process of 20, wherein the aluminum salt of sulfuric acid which is soluble in a monodisperse manner in water is Al₂(SO₄)₃.

29. The process of 23, wherein it is carried out a pressure range of from 1 to 5 bar.

30. The process of 23, wherein it is carried out at temperatures in the range from 80 to 95° C.
